(19) United States
(12) Patent Application Publication
(10) Pub. No.: US 2017/0311567 A1
(43) Pub. Date: Nov. 2, 2017

(54) VETERINARIAN E-BOWL

(71) Applicant: PetXperia, Inc., Studio City, CA (US)

(72) Inventor: Mary Ann Bridge, Studio City, CA (US)

(21) Appl. No.: 15/478,865

(22) Filed: Apr. 4, 2017

Related U.S. Application Data
(60) Provisional application No. 62/328,533, filed on Apr. 27, 2016.

(51) Int. Cl. A01K 5/01; A01K 7/00; A01K 15/04

(52) U.S. Cl. CPC A01K 5/0135; A01K 7/005; A01K 15/04

(57) ABSTRACT

A veterinarian e-bowl. The veterinarian e-bowl may be used in conjunction with an animal wearing an Elizabethan collar (“e-collar”) to assist the animal in consuming food and water while allowing the animal to retain the protective e-collar. Thus, the veterinarian e-bowl preferably allows the pet to eat or drink without removal of the e-collar during feeding. The veterinarian e-bowl may embody a small bowl for cats and small dog breeds weighing up to forty-eight pounds. In another embodiment, the veterinarian e-bowl may be directed to medium-size to large-size dog breeds having a weight in the range between approximately forty-nine pounds to eighty pounds.

### CROSS-REFERENCE TO RELATED APPLICATIONS

This Application claims the benefit of U.S. Provisional Patent Application No. 62/328,533, filed on Apr. 27, 2016, titled “Veterinarian E-Bowl”, by sole inventor Mary Ann Bridge, the contents of which are expressly incorporated herein by this reference as though set forth in their entirety.

### FIELD

The present disclosure relates generally to the field of bowls and feeding receptacles for animals, and more particularly, to pet bowls for domesticated animals (e.g., dog, cat) wearing an Elizabethan collar (“e-collar”).

### BACKGROUND

Veterinarian collars, cone collars, e collars, or e-collars are widely used to prevent an animal from licking or scratching an area subject to veterinarian treatment. An e-collar is a cone-like structure typically formed from a section of plastic sheet. The narrow end of the cone structure is usually fitted around the neck of the animal, while the opposing end flares away from the animal's neck in a conical manner. The size and length of the cone must generally be large enough, so that the forward end of the cone projects beyond the snout of the animal.

Unfortunately, after a pet undergoes surgical treatment and begins wearing an e-collar after being discharged from a veterinarian clinic, pet owners, before the present disclosure, had no effective solution for feeding his or her pet. Veterinarians may recommend that the pet owner supervise and/or hand feed the pet, but this may be become problematic in situations where the pet owner is unavailable and away from his or her pet.

Most pets wearing an e-collar also generally have difficulty in maneuvering, as the e-collar typically contacts free-standing objects. This may result with the head or upper body of the pet colliding with furniture or small objects lying stationary on a floor. More notably, the e-collar might even obstruct access to a pet bowl and thus might prevent the pet from consuming food or water from the pet bowl.

As a result of the pet not being able to eat or drink, many pet owners, sympathizing with their pets, might adjust or remove the e-collar during the healing period especially during periods when the pet desires to eat or drink out of its pet bowl. Failing to properly reattach the e-collar in a timely manner, however, may cause the pet to harm itself. As a result, the pet owner might need to revisit the veterinarian clinic to address any harm caused by the pet. Because it can take less than thirty seconds for an animal to remove its sutures, pet owners must be very cautious when removing the e-collar from their pet.

Furthermore, a pet wearing an e-collar generally requires special aid and assistance when accessing its food or water bowl. Thus, secondary problems might occur for working pet owners, as they frequently leave their pets unattended at home while away at work.

Therefore, there is a need for a new and improved pet bowl or receptacle compatible for a pet wearing an e-collar. The bowl or receptacle may be provided by veterinarians during post-operative or medical treatment healing periods to enable the cat or dog to eat and drink unaided while continuously wearing the e-collar. Preferably, the pet bowl or receptacle allows the pet to consume food and water free from dependence, aid, and supervision during post-surgical healing periods.

### SUMMARY OF EMBODIMENTS

The present specification discloses a new and improved veterinarian Elizabethan bowl (“e-bowl”).

One embodiment may be a veterinarian e-bowl compatible for an animal wearing an e-collar, comprising: an outer sidewall, a rim portion, an outer sidewall, a base portion, and a receptacle portion; wherein an upper end of the outer sidewall may join an outer diameter of the rim portion and a lower end of the outer sidewall may join the base portion; wherein the outer sidewall may extend outwardly and downwardly away from the rim portion to the base portion, such that the outer sidewall is substantially frustum-shaped; wherein the receptacle portion may comprise an inner sidewall and a bottom; wherein an upper end of the inner sidewall of the receptacle portion may join at an inner diameter of the rim portion; wherein the inner sidewall may surround the bottom and may extend at least downwards to the bottom; wherein the receptacle portion may be elevated at a height of at least approximately half of a height of the animal; and wherein a top portion of the veterinarian e-bowl may be dimensioned to fit at least partially within an interior space of an e-collar worn by an animal, such that the animal may be capable of consuming food and water located within a cavity of the receptacle portion of the veterinarian e-bowl.

The veterinarian e-bowl may be a first veterinarian e-bowl; and wherein the rim portion, the inner sidewall and an upper portion of the outer sidewall of the first veterinarian e-bowl may form a circumferential space adapted to engage an upper portion of a second veterinarian e-bowl in order to facilitate nesting for the second veterinarian e-bowl, such that when an upper portion of the second veterinarian e-bowl is inserted through a bottom opening of the first veterinarian e-bowl, the upper portion of the second veterinarian e-bowl may engage into the circumferential space of the first veterinarian e-bowl. The circumferential space of the first veterinarian e-bowl may comprise at least one rib to prevent jamming during the nesting. A top opening of the receptacle may be adapted to fit and matingly receive a smaller bowl. The veterinarian e-bowl may lack at least one protrusion.

The veterinarian e-bowl may further comprise a non-skid material disposed at least beneath the base portion to diminish skidding. The non-skid material may be a gasket. The base portion may comprise an outer flange surrounding the base portion, such that the outer flange may also be substantially circular; and wherein the non-skid material may be disposed at least beneath of at least a portion of the outer flange of the e-bowl.

An outer surface of the outer sidewall may be smooth. The sidewall may comprise at least one finger grip opening. The inner sidewall may slope inwardly.

The veterinarian e-bowl may be constructed of an FDA-approved material. A weight of the base portion may be substantially heavier than the rim portion, such that the veterinarian e-bowl may be bottom weighted and substantially stable when resting on a horizontal surface. The veterinarian e-bowl may weigh between approximately 0.5 to 2.5 pounds, such that the veterinarian e-bowl is lightweight. The veterinarian e-bowl may be constructed of a polymer. The veterinarian e-bowl may be constructed of a metal. The veterinarian e-bowl may be constructed of a dishwasher safe material. The dishwasher safe material may be selected from the group of materials consisting of: a glass, a plastic, and a ceramic. The veterinarian e-bowl may be constructed of a microwave safe material. The microwave safe material may not be material that is not a metal.

Another embodiment may be a veterinarian e-bowl designed for dogs.

Another embodiment may be a veterinarian e-bowl designed for cats.

Another embodiment may be a veterinarian e-bowl designed to hold food, water, or the like for pets.

Another embodiment may be a veterinarian e-bowl constructed as a single piece with a smaller, built-in upper chamber or bowl.

Another embodiment may be a veterinarian e-bowl with an interior space located from the bottom end of the base portion of the shell up to the receptacle portion of the veterinarian e-bowl at the top end portion.

Another embodiment may be a veterinarian e-bowl with a receptacle designed to receive or accept a smaller, drop-in food or water bowl, thereby eliminating any need for a smaller, built-in bowl.

Another embodiment may be a veterinarian e-bowl constructed of FDA-approved material that is safe for food or water consumption for an animal.

Another embodiment may be a veterinarian e-bowl that may be constructed of various materials, including without limitation, polymers, such as plastic, and metals, such as stainless steel.

Another embodiment may be a veterinarian e-bowl constructed at a particular height and dimension for use with cats.

Another embodiment may be a veterinarian e-bowl constructed at a particular height and dimensions for use with dogs.

Another embodiment may be a veterinarian e-bowl that is sloped in design.

Another embodiment may be a veterinarian e-bowl that is sturdy and stable.

Another embodiment may be a veterinarian e-bowl that is lightweight.

Another embodiment may be a veterinarian e-bowl with a flange having a non-skid material.

Another embodiment may be a veterinarian e-bowl with a gasket to minimize skidding.

Another embodiment may be a veterinarian e-bowl that is smooth-surfaced and is painted to promote aesthetics.

Another embodiment may be a veterinarian e-bowl capable of nesting.

Another embodiment may be a veterinarian e-bowl with one or more rib portions and/or projections to prevent jamming during nesting.

Another embodiment may be a veterinarian e-bowl that is frustum-shaped.

Another embodiment may be a veterinarian e-bowl without any protruding parts other than a bottom gasket.

Another embodiment may be a veterinarian e-bowl that promotes ease of food and water consumption by cats or dogs wearing an e-collar.

Another embodiment may be a veterinarian e-bowl adapted to allow pets such as cats and dogs wearing an e-collar during postoperative healing periods to eat and drink without requiring the removal of the e-collar.

Another embodiment may be a veterinarian e-bowl engineered and designed for sale to veterinarian clinics only.

Another embodiment may be a veterinarian e-bowl that may later be modified and offered for sale directly to the public as a food or water bowl for domestic cats or dogs.

Another embodiment may be a large veterinarian e-bowl of a size and shape that assists large dog breeds with a weight in the range between approximately 20 lbs. to 75 lbs. but may also function well with dog breeds of larger sizes.

Another embodiment may be a small veterinarian e-bowl of a size and shape that assists smaller pets such as domestic cats and dogs in weight between approximately 8 lbs. to 30 lbs. and tested at 9.5 lbs.

Another embodiment may be a veterinarian e-bowl that may comprise one or more finger grip holes or cutouts for convenient lifting. In other embodiments, however, the finger grip holes may be unnecessary due to light weight of the bowl or receptacle.

Another embodiment may be a veterinarian e-bowl that is dishwasher safe and/or microwave safe.

An Elizabethan collar (“e-collar”) is generally a removable, protective collar, typically in the shape of a hollow expanding frustum. The narrow or proximal portion of the frustum shaped e-collar may comprise fastening members to secure and fasten that narrow portion of the e-collar around a neck of an animal. Other fastening members may also be disposed along opposing sides of the e-collar and may also be coupled together to complete the expanding frustum shape. Thus, the e-collar typically expands away from the narrow portion of the frustum-shaped end and usually expands to a widest location at a distal end of the frustum shaped e-collar. The e-collar may form the frustum shape to prevent the animal from reaching a location on its body where surgery or some other medical procedure has been performed.

The problem addressed by the present disclosure is to allow an animal or pet wearing an e-collar to eat or drink with minimal supervision. Currently, most pet owners typically unfasten and/or remove an e-collar to allow the animal to eat or drink. This is typically a time consuming, attention demanding, and cumbersome process, as it requires the pet owner or care-giver to: (1) unfasten the e-collar, (2) wait until the animal has completed its food or water consumption, and (3) then re-fastening the e-collar. Alternatively, the pet owner may have to hand feed his or her pet during feeding. Thus, the embodiments disclosed in the present disclosure help reduce and minimize the possibility of the animal orally engaging with an area of its body that is wounded or subject to a surgical procedure. Without the embodiments disclosed herein, the pet owner may remove the e-collar from the animal, and the animal consuming food or water may also lick or bite at the suture or location required for healing. As a result, the e-collar is designed to prevent this type of behavior.

The veterinarian e-bowl may include various embodiments of a pet bowl having: (1) an outer sidewall substantially taller than conventional pet bowls, (2) a rim portion of a given size, (3) a receptacle portion into which food or water may be placed, and (4) a base portion that fits within the space within the e-collar so that the pet may consume food or water out of the bowl without removal of the e-collar.

The size of the bowl may depend upon the size of the e-collar and the size of the animal. The embodiments disclosed herein may include veterinarian e-bowls of various sizes. For instance, one embodiment may include a small pet bowl to accommodate a cat or small dog weighing up to 46 pounds. Another embodiment may also include a larger bowl to accommodate a medium to large dog weighing up to 78 pounds. Various embodiments may also allow nesting to accommodate shipment and storage. This is especially helpful for veterinarian offices utilizing veterinarian e-bowl. In other embodiments, the veterinarian e-bowl may have any color and may be constructed of various materials such as plastic or metal. The veterinarian e-bowl may also be placed on the ground for smaller dog breeds or at an elevated position to accommodate larger dog breeds.

In one embodiment, the veterinarian e-bowl may be sized to fit within the space of the e-collar, so that the animal may consume food or water while wearing the e-collar. The veterinarian e-bowl may also comprise a receptacle portion comprising an inner sidewall extending downwardly to a bottom forming a cavity and having a given depth and shape to facilitate the insertion of appropriate food or water. The body of the veterinarian e-bowl may terminate at the base portion, which may comprise a flange, which may be circular. In other embodiments, the veterinarian e-bowl may comprise a non-skid material (e.g., gasket) positioned around the flange to minimize skidding, slipping, or moving of the veterinarian e-bowl while the pet is consuming food or water. Another embodiment of the veterinarian e-bowl may comprise one or more finger grip holes for lifting. Still, in another embodiment, the receptacle portion may be integrally formed with the rim portion and may extend into a cavity surrounded by the inner sidewall. In other embodiments, the veterinarian e-bowl may comprise bumps or protrusions positioned at the surface of the bottom of the receptacle portion to help facilitate removal of a first veterinarian e-bowl from an adjacent nested second veterinarian e-bowl.

In one embodiment, the veterinarian e-bowl may be a single piece while, in other embodiments, the veterinarian e-bowl may comprise multiple pieces. For example, the veterinarian e-bowl may comprise first section having a rim portion extending to the receptacle portion and a second section forming the receptacle portion for holding food or water.

In another embodiment, the veterinarian e-bowl may be sized to fit within at least a portion of the interior space of the e-collar, so that a distal end of the e-collar does not contact the floor and allow the animal to eat or drink from the receptacle portion of the veterinarian e-bowl.

In other embodiments, the veterinarian e-bowl may accommodate variations of the e-collar such as a collar formed from polygonal sidewalls (including pentagonal, hexagon and octagon).

It is an object to provide an animal food and water bowl that allows an animal to eat food and drink water while continuously wearing the e-collar.

It is another object to provide a veterinarian e-bowl of various sizes. For example, a smaller veterinarian e-bowl may fit for cats and small dogs, whereas a larger veterinarian e-bowl may fit for medium to large dog breeds. Other sized configurations to accommodate other animals are also contemplated, as the size of the veterinarian e-bowl will depend upon the size of the e-collar and size of the animal. For example, one size, may be used to accommodate all cats and small dogs up to 46 pounds, whereas another size may be used for larger dogs weighing about approximately 78 pounds.

These, as well as other components, steps, features, objects, benefits, and advantages, will now become clear from a review of the following detailed description of illustrative embodiments, of the accompanying drawings, and of the claims.

### BRIEF DESCRIPTION OF THE ILLUSTRATIVE EMBODIMENTS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

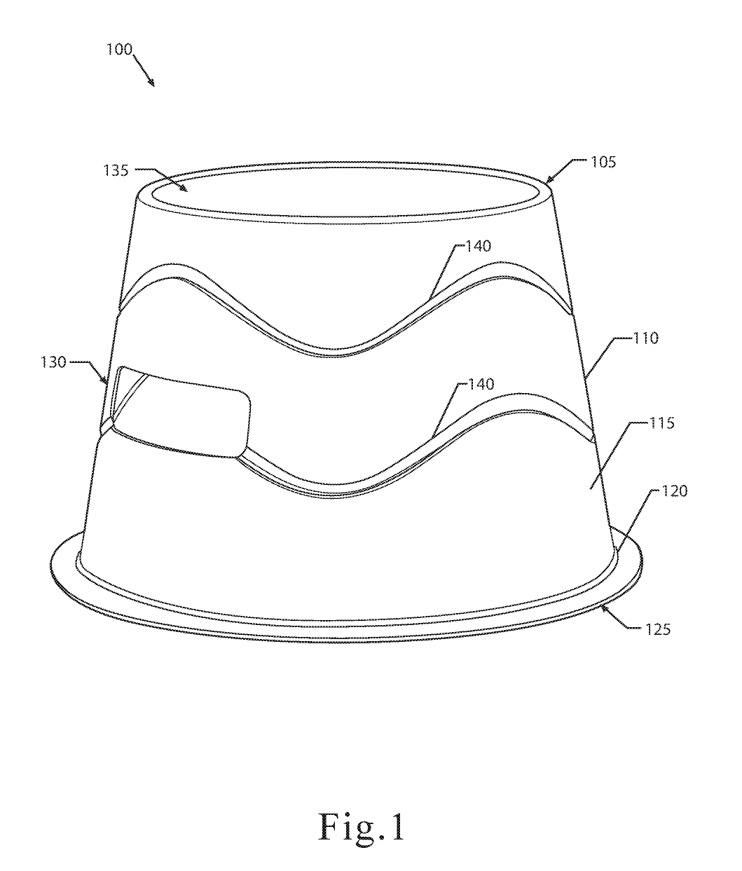

FIG. 1 is a top perspective view of a one embodiment of a veterinarian e-bowl.

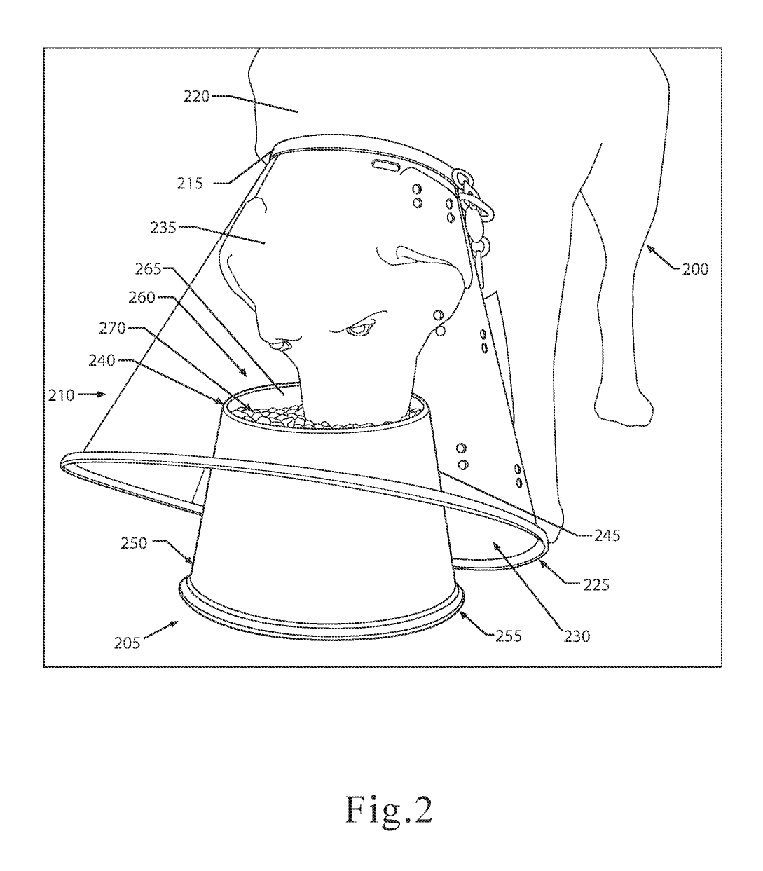

FIG. 2 is an illustration of another embodiment of the veterinarian e-bowl and shows a medium-large dog wearing an e-collar feeding from the veterinarian e-bowl.

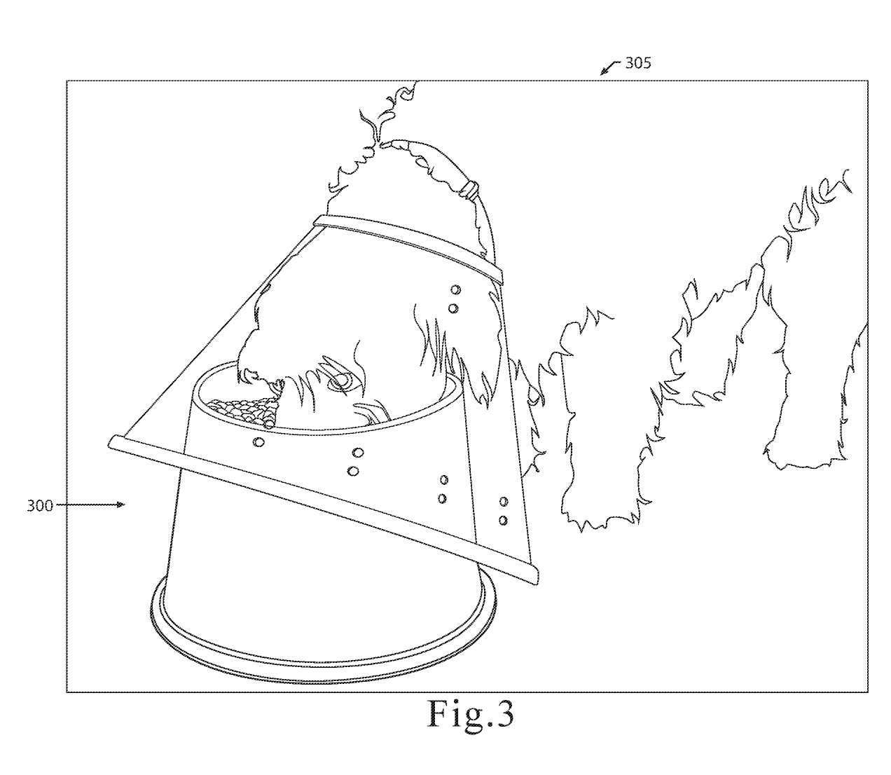

FIG. 3 is an illustration of another embodiment of the veterinarian e-bowl and shows a small dog wearing an e-collar feeding from the veterinarian e-bowl.

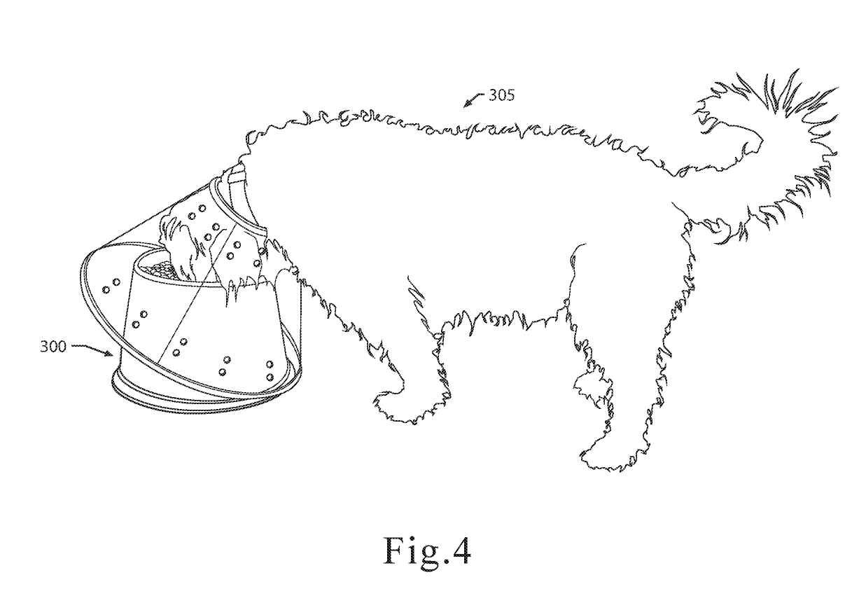

FIG. 4 is an illustration of another embodiment of the veterinarian e-bowl and shows a small dog wearing an e-collar feeding from the veterinarian e-bowl.

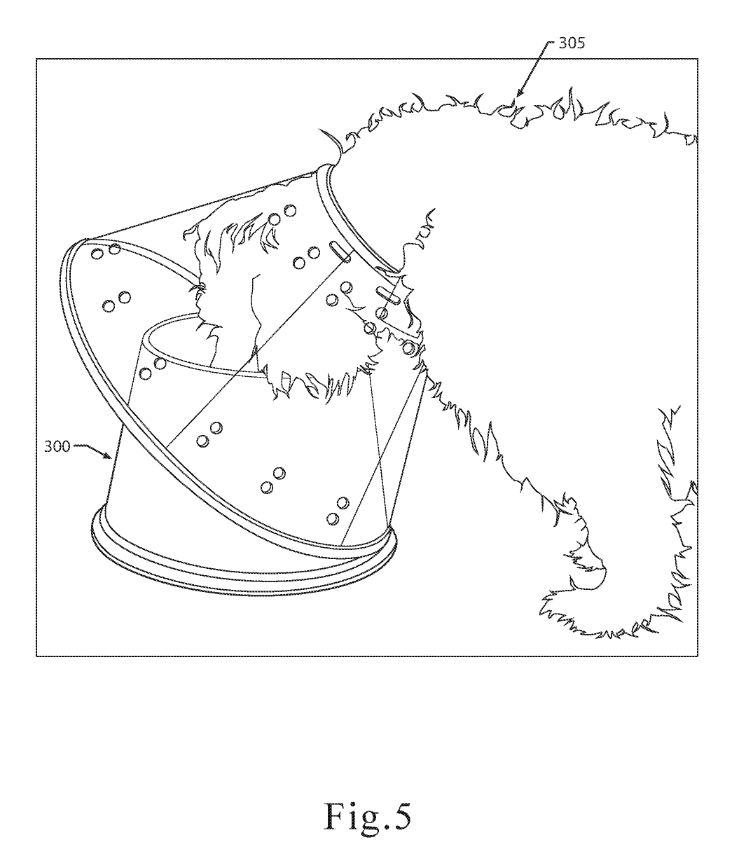

FIG. 5 is an illustration of another embodiment of the veterinarian e-bowl and shows a small dog wearing an e-collar feeding from the veterinarian e-bowl.

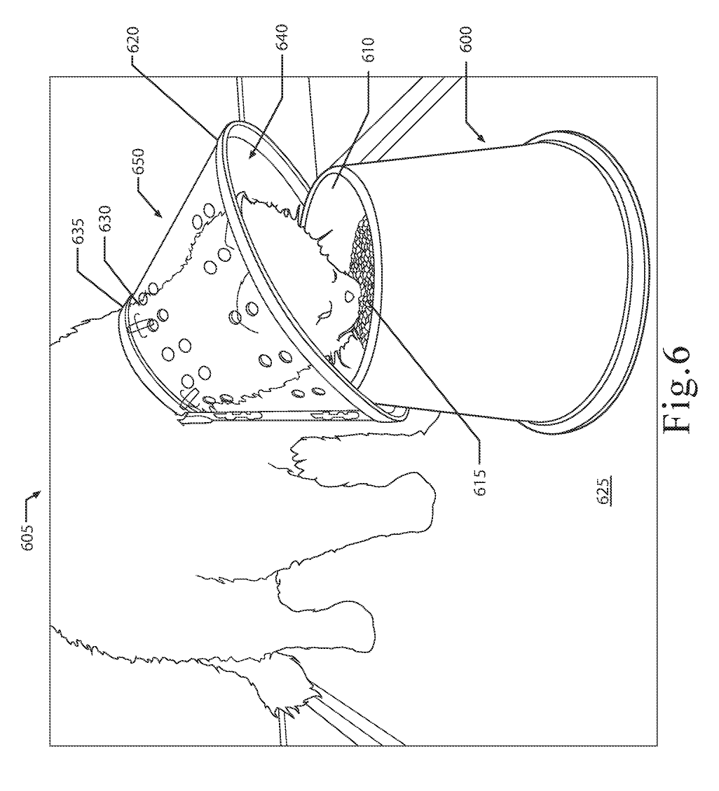

FIG. 6 is an illustration of another embodiment of the veterinarian e-bowl and shows a cat wearing an e-collar feeding from the veterinarian e-bowl without having the e-collar contact the ground surface.

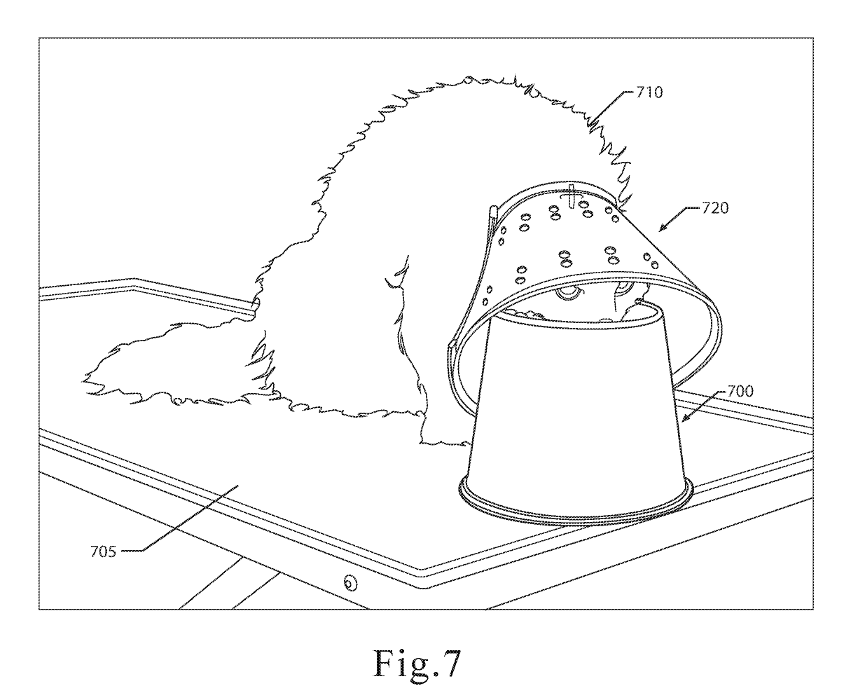

FIG. 7 is an illustration of another embodiment of the veterinarian e-bowl and shows a cat wearing an e-collar feeding from the veterinarian e-bowl without having the e-collar contact the ground surface.

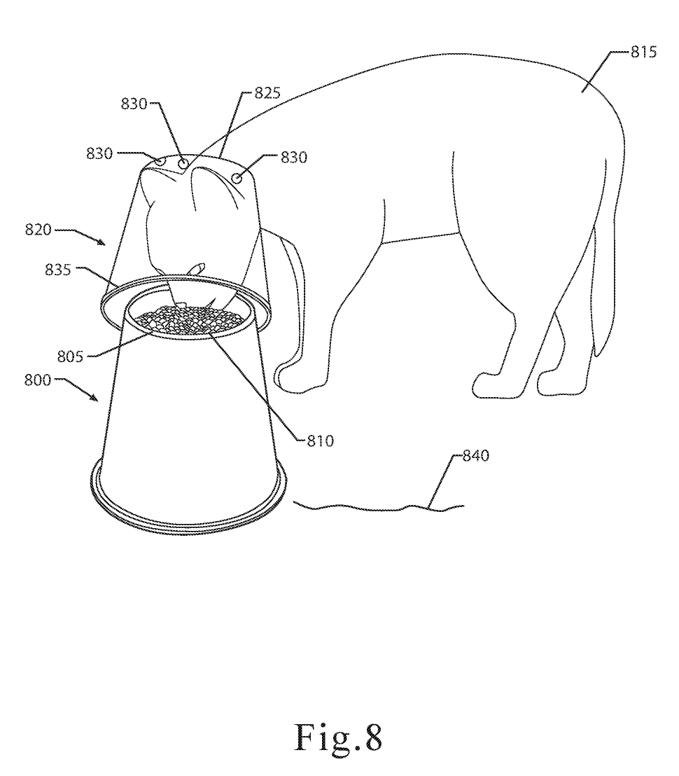

FIG. 8 is an illustration of another embodiment of the veterinarian e-bowl and shows a cat wearing an e-collar feeding from the veterinarian e-bowl without having the e-collar contact the ground surface.

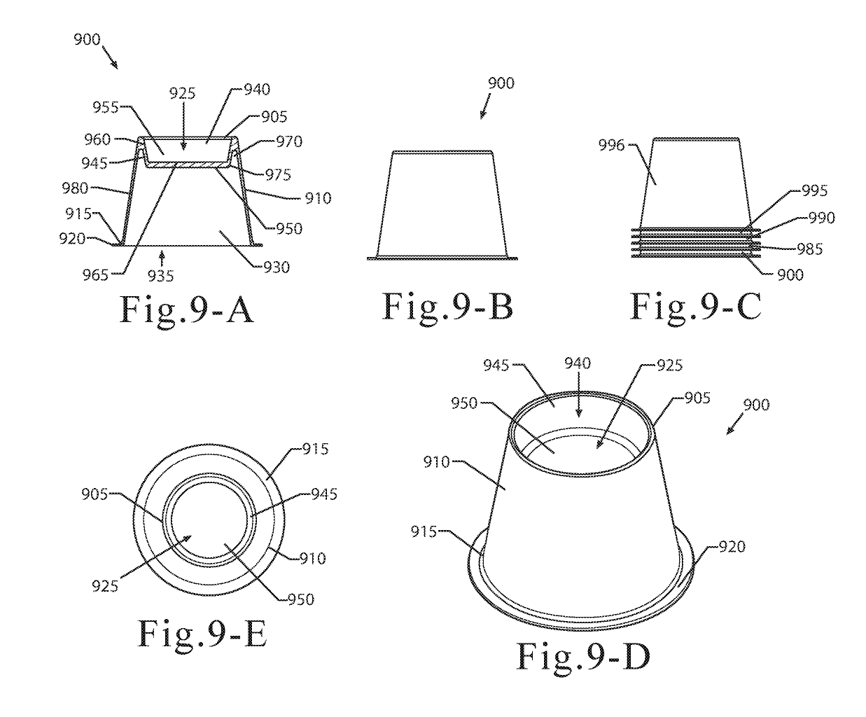

FIG. 9-A is an illustration of a cross section view of another embodiment of a veterinarian e-bowl for a cat or small dog.

FIG. 9-B is an illustration of a side elevational view of another embodiment of a veterinarian e-bowl for a cat or small dog.

FIG. 9-C is an illustration of a side elevational view of another embodiment of a plurality of veterinarian e-bowls for a cat or small dog and shows the veterinarian e-bowls stacked and nested together.

FIG. 9-D is an illustration of a top perspective view of another embodiment of a veterinarian e-bowl for a cat or small dog.

FIG. 9-E is an illustration of a top plan view of another embodiment of a veterinarian e-bowl for a cat or small dog.

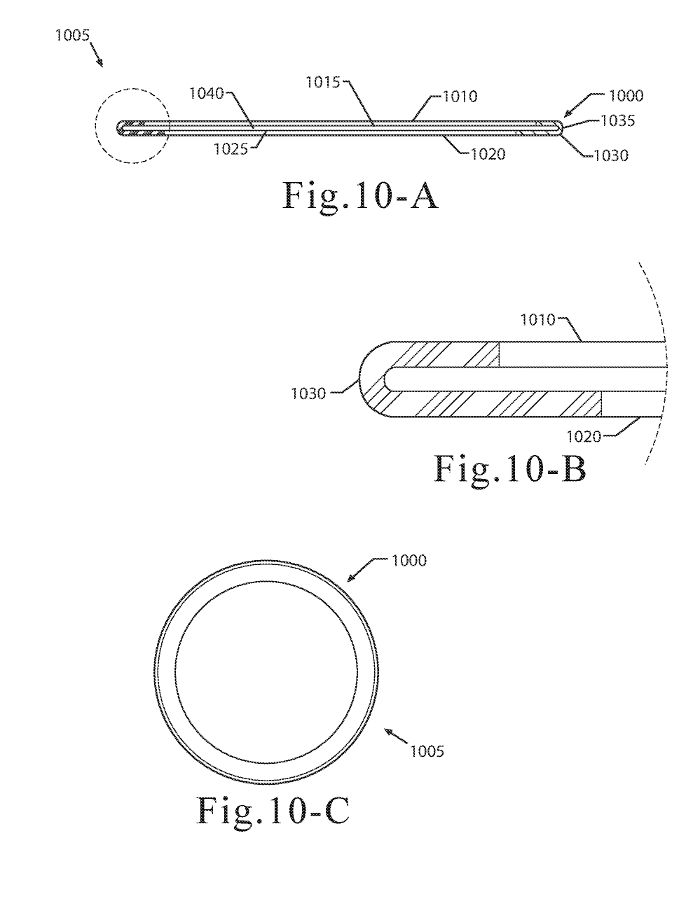

FIG. 10-A is an illustration of a cross-sectional view of one embodiment of a non-skid material for veterinarian e-bowl for a cat or small dog.

FIG. 10-B is an illustration of an enlarged view of one embodiment of an end portion of the non-skid material for veterinarian e-bowl for a cat or small dog.

FIG. 10-C is an illustration of a top plan view of one embodiment of the non-skid material for veterinarian e-bowl for a cat or small dog.

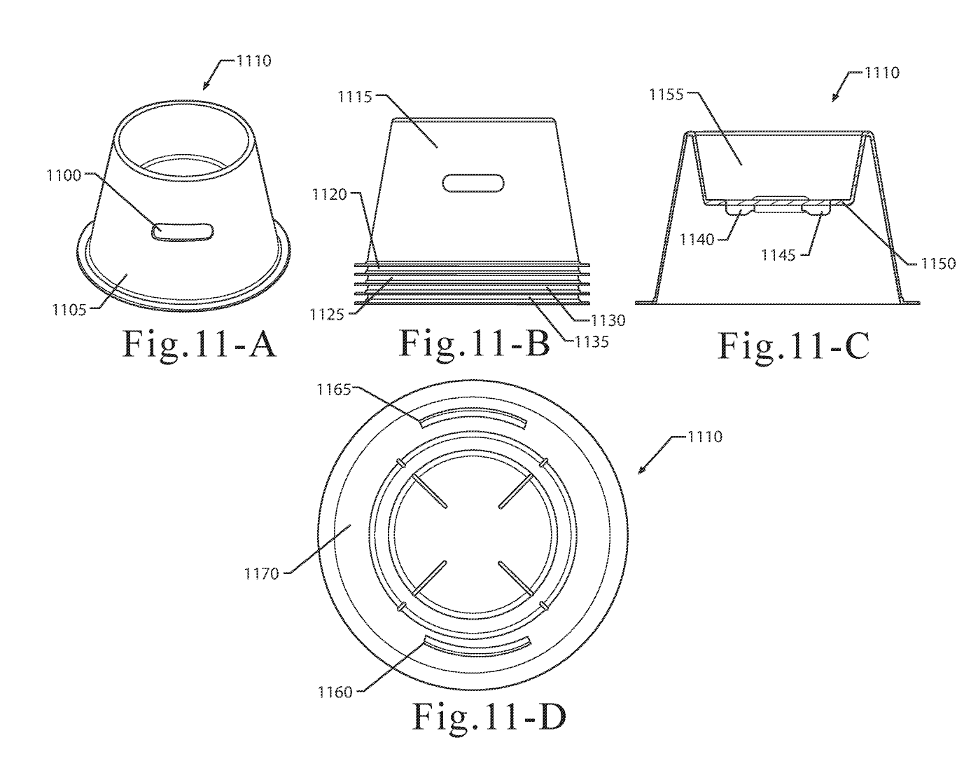

FIG. 11-A is an illustration of a top perspective view of another embodiment of the veterinarian e-bowl for a cat and small dog and shows the veterinarian e-bowl with at least one finger grip member.

FIG. 11-B is an illustration of a side view of a plurality of veterinarian e-bowls for a cat and small dog and shows the veterinarian e-bowls stacked and nested together.

FIG. 11-C is an illustration of a cross section view of another embodiment of the veterinarian e-bowl for a cat and small dog and shows a pair of bumps or protrusions extending from the bottom of the receptacle portion to help facilitate removal when stacked or nested.

FIG. 11-D is an illustration of a bottom plan view of another embodiment of the veterinarian e-bowl for a cat and small dog and shows a plurality of ribs to help facilitate removal when stacked or nested.

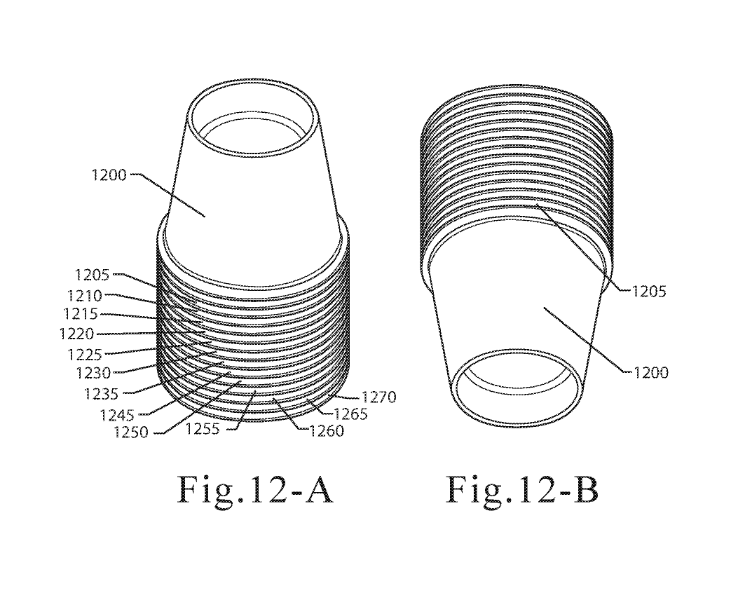

FIG. 12-A is an illustration of a top perspective view of a plurality of another embodiment of the veterinarian e-bowls for a cat or small dog and shows the veterinarian e-bowls stacked and nested with the base portion of the veterinarian e-bowls facing downwards.

FIG. 12-B is an illustration of a bottom perspective view of plurality of another embodiment of the veterinarian e-bowls for a cat or small dog and shows the veterinarian e-bowls stacked and nested with the rim portion of the veterinarian e-bowls facing downwards.

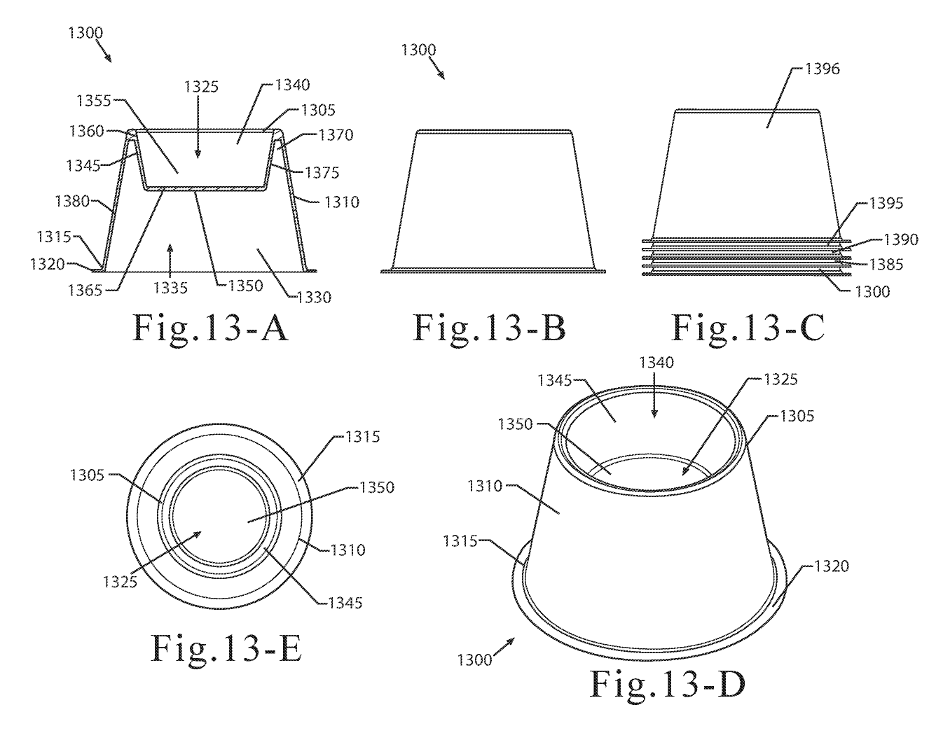

FIG. 13-A is an illustration of a cross-sectional view of one embodiment of a veterinarian e-bowl.

FIG. 13-B is an illustration of a side elevational view of another embodiment of a veterinarian e-bowl for medium to large dogs.

FIG. 13-C is an illustration of a side elevational view of a plurality of another embodiment of the veterinarian e-bowl for a medium to large dog and shows the veterinarian e-bowls stacked and nesting together.

FIG. 13-D is an illustration of a top perspective view of one embodiment of the veterinarian e-bowl for a medium to large dog wearing an e-collar.

FIG. 13-E is an illustration of a top view of one embodiment of the veterinarian e-bowl for a medium to large dog wearing an e-collar.

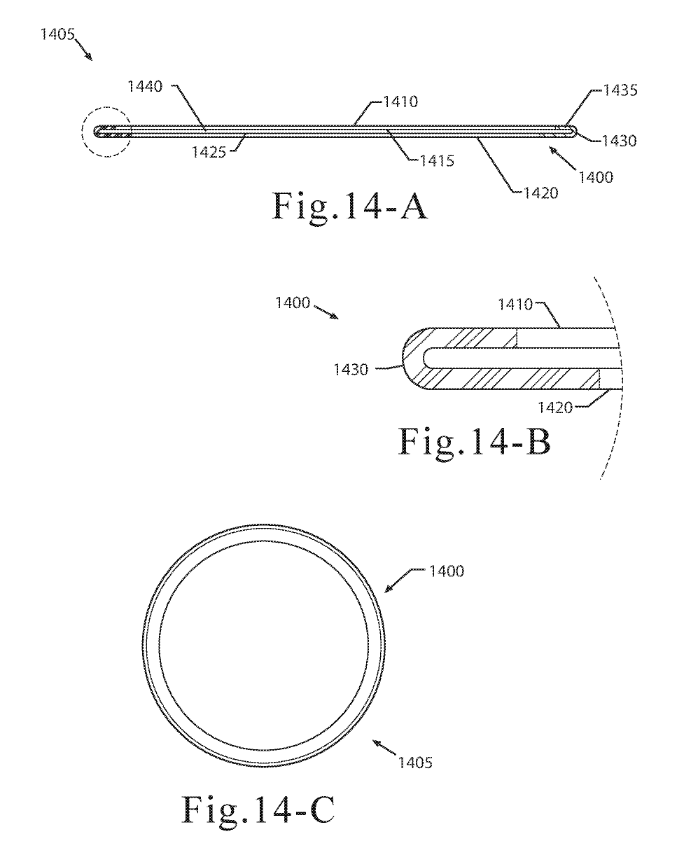

FIG. 14-A is an illustration of a cross-sectional view of one embodiment of a non-skid material for veterinarian e-bowl for a medium to large dog.

FIG. 14-B is an illustration of an enlarged view of one embodiment of a non-skid material for veterinarian e-bowl for a medium to large dog.

FIG. 14-C is an illustration of a top plan view of one embodiment of the non-skid material for veterinarian e-bowl for a medium to large dog.

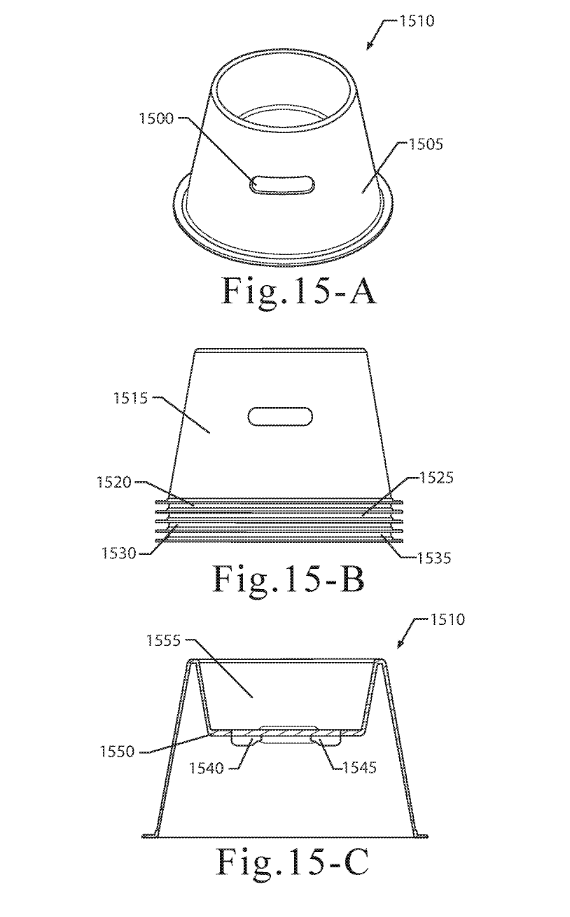

FIG. 15-A is an illustration of a top perspective view of another embodiment of the veterinarian e-bowl for a medium to large dog and shows the veterinarian e-bowl with at least one finger grip member.

FIG. 15-B is an illustration of a side view of a plurality of veterinarian e-bowls for a medium to large dog and shows the veterinarian e-bowls stacked and nested together.

FIG. 15-C is an illustration of a cross section view of another embodiment of the veterinarian e-bowl for a medium to large dog and shows a pair of bumps or protrusions extending from the bottom of the receptacle portion to help facilitate removal when stacked or nested.

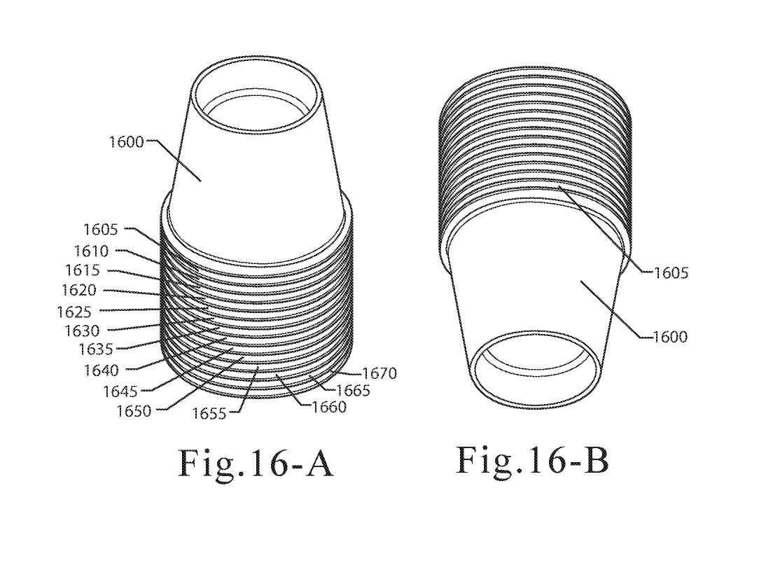

FIG. 16-A is an illustration of a top perspective view of a plurality of another embodiment of the veterinarian e-bowls for a medium to large dog and shows the veterinarian e-bowls stacked and nested with the base portion of the veterinarian e-bowls facing downwards.

FIG. 16-B is an illustration of a bottom perspective view of plurality of another embodiment of the veterinarian e-bowls for a medium to large dog and shows the veterinarian e-bowls stacked and nested with the rim portion of the veterinarian e-bowls facing downwards.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the term “pet” refers to a domestic or tamed animal such as a dog or cat.

As used herein, the terms “approximately” and “about” generally refer to a deviance of within 5% of the indicated number or range of numbers. In one embodiment, the term “approximately” and “about”, refer to a deviance of between 1-10% from the indicated number or range of numbers.

FIG. 1 is a top perspective view of a one embodiment of a veterinarian e-bowl. As shown in FIG. 1, the veterinarian e-bowl 100 may comprise a rim portion 105 that extends downwardly via a sloped exterior circumferential outer sidewall 110 and terminates at a base portion 115 having an exterior circumferential flange 120. The flange 120 may comprise a non-skid material 125 retained at least partially over the circumferential flange 120. The outer sidewall 110 may comprise at least one finger grip opening 130. The rim portion 105 may be integrally formed with a receptacle portion 135. In one embodiment, the veterinarian e-bowl 100 may comprise a decorative design 140 located on the outer sidewall 110.

The veterinarian e-bowl may comprise at least two embodiments. A first embodiment may be a veterinarian e-bowl designed for cats and small dogs weighing up to 48 pounds. A second embodiment may be a veterinarian e-bowl designed for medium to large dogs having a weight in the range from approximately 49 pounds to 80 pounds, with a preferred maximum weight for a large dog being 78 pounds.

### Embodiments of Veterinarian E-Bowl for Cats and Small Dogs

FIG. 2 is an illustration of another embodiment of the veterinarian e-bowl and shows a medium to large dog wearing an e-collar feeding from the veterinarian e-bowl. As shown in FIG. 2, a medium to large dog 200 may feed from the veterinarian e-bowl 205 when the dog 200 is wearing an e-collar 210 having a proximal end 215 fastened around its neck 220 and a distal end 225 forming an interior chamber 230 within the e-collar 210 into which the head 235 of the dog 220 may be placed. The veterinarian e-bowl 205 may comprise a rim portion 240 extending to a downwardly sloped outer sidewall 245 and terminating at a base portion 250. The base portion 250 may comprise a flange 255 and the flange 225 may comprise a non-skid material retained at least partially over the flange 255. The outer sidewall 245 may comprise at least one finger grip opening such that the veterinarian e-bowl 205 is easily moveable. The rim portion 240 may be integrally formed with a receptacle portion 260 and the outer sidewall 245 may surround an interior space extending from the rim portion 240 to a bottom opening surrounded by a base portion 250. The receptacle portion 260 may comprise a top opening surrounded by the rim portion 240, and may comprise an inwardly sloped inner sidewall 265 terminating at a bottom. The top opening may lead to a cavity 270 surrounded by an interior surface of the inner sidewall 265 and an interior surface of the bottom. A circumferential space may be disposed between an exterior surface of the inner sidewall 265 and an interior surface of the outer sidewall 245. The circumferential space may facilitate nesting of a plurality of veterinarian e-bowls by facilitating the insertion of an upper rim of a second veterinarian e-bowl through a bottom opening of a first veterinarian e-bowl 205 with the cavity and interior surface of the second veterinarian e-bowl inserted around an exterior surface of the inner sidewall 265 of the first veterinarian e-bowl 205 and whereby the first veterinarian e-bowl 205 may be configured to enable a pet 200 to consume food within the cavity 270 of the first veterinarian e-bowl 205 when an e-collar 210 is fastened around its neck 220.

FIGS. 3 through 5 are illustrations of another embodiment of the veterinarian e-bowl and show a small dog wearing an e-collar feeding from the veterinarian e-bowl. As shown in FIGS. 3 through 5, the veterinarian e-bowl 300 may be designed of a size and shape that assists smaller pets such as domestic dogs 305 in weight between approximately 8 lbs. to 30 lbs.

FIG. 6 is an illustration of another embodiment of the veterinarian e-bowl and shows a cat wearing an e-collar feeding from the veterinarian e-bowl without having the e-collar contact the ground surface. As shown in FIG. 6, the veterinarian e-bowl 600 may be adapted for use with pets such as domestic cats 605. The veterinarian e-bowl 600 may comprise a receptacle portion 610 adapted to hold and retain food 615 or water to allow a pet (e.g., cat) 605 wearing an e-collar 650 to access the food 615 or water. The e-collar 650 may partially extend over the veterinarian e-bowl 600 without having its distal end 620 completely contacting the surface 625 on which the cat 605 and veterinarian e-bowl 600 is placed. The e-collar 600 may have a proximal end 630 fastened around the neck 635 of the cat 605 and may comprise an interior space 640 within the e-collar 600 into which the head of the cat 605 may be positioned.

FIG. 7 is an illustration of another embodiment of the veterinarian e-bowl and shows a cat wearing an e-collar 720 feeding from the veterinarian e-bowl without having the e-collar contact the ground surface. As shown in FIG. 7, the veterinarian e-bowl 700 may be placed on a table 705 such as a table at a veterinarian clinic, to assist pets such as domestic cats 710 and dogs in feeding while they are in the care of a veterinarian clinic.

FIG. 8 is an illustration of another embodiment of the veterinarian e-bowl and shows a cat wearing an e-collar feeding from the veterinarian e-bowl without having the e-collar contact the ground surface. As shown in FIG. 8, another embodiment of a veterinarian e-bowl 800 may comprise a receptacle portion 805 adapted to hold and retain cat food 810 or water and may be sized to allow the cat 815 to consume cat food 810 or water while the cat 815 has an e-collar 820 around its neck 825. Fastening members 830 may close and secure the e-collar around the neck 825 of the cat 815. FIG. 8 also shows that the e-collar 820 may partially extend over the veterinarian e-bowl 800 without having the distal end 835 of the e-collar 820 contacting the ground surface 840.

FIGS. 9-A through 9-E are illustrations of another embodiment of a veterinarian e-bowl for a cat or small dog. FIG. 9-A is an illustration of a cross section view of another embodiment of a veterinarian e-bowl for a cat or small dog. FIG. 9-A shows that the veterinarian e-bowl 900 may comprise a rim portion 905, a downwardly sloped circumferential outer sidewall 910, and a base portion 915. FIG. 9-A also shows that the veterinarian e-bowl 900 may comprise a flange 920 with a non-skid material (as shown in FIG. 9-D) retained at least partially over the flange 920. The outer sidewall 910 may comprise at least one finger grip opening. The rim portion 905 may be integrally formed with a receptacle portion 925. The outer sidewall 910 may form an interior chamber 930 extending from the rim portion 905 to a bottom opening 935 surrounded by the base portion 915. The receptacle portion 925 may have a top opening 940 surrounded by the rim portion 905 and an inner sidewall 945 terminating to a bottom 950. The top opening 940 may lead to a cavity 955 surrounded by an interior surface 960 of the inner sidewall 945 and an interior surface 965 of bottom 950. A circumferential space 970 may be disposed between the exterior surface 975 of the inner sidewall 945 and the interior surface 980 of outer sidewall 910. The circumferential space 970 may help nest multiple veterinarian e-bowls (as shown in FIG. 9-C) by having the rim portion 905 of a first veterinarian e-bowl 900 inserted through a bottom opening of a second veterinarian e-bowl.

The top opening 940 may comprise a diameter less than the diameter of the base opening 935. The rim portion 905 may comprise a diameter greater than the diameter of the top opening 940 and less than the diameter of the base opening 935.

FIG. 9-B is an illustration of a side elevational view of another embodiment of a veterinarian e-bowl for a cat or small dog. The veterinarian e-bowl 900 may have a preferred height of approximately 4.25 inches.

FIG. 9-C is an illustration of a side elevational view of another embodiment of a plurality of veterinarian e-bowls for a cat or small dog and shows the veterinarian e-bowls stacked and nested together. As shown in FIG. 9-C, a stacked or nesting configuration may include veterinarian e-bowls 900, 985, 990, 995 and 1000. In the stacked or nesting configuration, the rim portion of a first veterinarian e-bowl 900 may be inserted through a bottom opening of a second veterinarian e-bowl 985. Similarly, the rim portion of the second veterinarian e-bowl 985 may be inserted through a bottom opening of a third veterinarian e-bowl 990. This process may be repeated to stack or nest as many veterinarian e-bowls as desired.

FIG. 9-D is an illustration of a top perspective view of another embodiment of a veterinarian e-bowl for a cat or small dog. As shown in FIG. 9-D, the veterinarian e-bowl 900 may comprise a rim portion 905, a downwardly sloped circumferential outer sidewall 910 and a base portion 915. The rim portion 905 may be integrally formed with a receptacle portion 925. The outer sidewall 910 may form an interior chamber extending from the rim portion 905 to a bottom opening surrounded by the base portion 915. The receptacle portion 925 may have a top opening 940 surrounded by the rim portion 905 and may lead to a cavity surrounded by an inner sidewall 945 and a bottom 950. FIG. 9-D also shows that the veterinarian e-bowl 900 may comprise a flange 920 with a non-skid material retained at least partially over the flange 920.

FIG. 9-E is an illustration of a top plan view of another embodiment of a veterinarian e-bowl for a cat or small dog. As shown in FIG. 9-E, the rim portion 905 may be integrally formed with a receptacle portion 925. The receptacle portion 925 may be surrounded by the rim portion 905 and an inner sidewall 945 terminating to a bottom 950. The outer sidewall 910 may extend from the rim portion 905 to a base portion 915.

FIGS. 10-A through 10-C are illustrations of one embodiment of a non-skid material for veterinarian e-bowl for a cat or small dog. FIG. 10-A is an illustration of a cross-sectional view of one embodiment of a non-skid material for veterinarian e-bowl for a cat or small dog. As shown in FIG. 10-A, a non-skid material 1000 may be disposed over and around the flange 1005 of the veterinarian e-bowl. The non-skid material 1000 may comprise an upper section 1010 having an interior surface 1015 and a lower section 1020 also having an interior surface 1025. The upper section 1010 and the lower section 1020 may be joined and integrally rounded by a sidewall 1030, which may have an interior surface 1035. A circumferential space 1040 may be formed and surrounded by interior surfaces 1015, 1025, and 1035. The flange 1005 may be located within a circumferential space 1040.

FIG. 10-B is an illustration of an enlarged view of one embodiment of an end portion of the non-skid material for veterinarian e-bowl for a cat or small dog. As shown in FIG. 10-B, one embodiment of an end portion of the non-skid material 1000 may comprise a rounded circumferential sidewall 1030, upper section 1010, and lower section 1020, wherein upper section 1010, and lower section 1020 are enlarged from the circle portion of the non-skid material 1000 illustrated in FIG. 10-A.

FIG. 10-C is an illustration of a top plan view of one embodiment of the non-skid material for veterinarian e-bowl for a cat or small dog. As shown in FIG. 10-C, the non-skid material 1000 may be disposed over and around the flange 1005 of the veterinarian e-bowl.

FIGS. 11-A through 11-D are illustrations of another embodiment of the veterinarian e-bowl with at least one finger grip opening for a cat and small dog. FIG. 11-A is an illustration of a top perspective view of another embodiment of the veterinarian e-bowl for a cat and small dog and shows the veterinarian e-bowl with at least one finger grip member. As show in FIG. 11-A, the finger grip member 1100 may be located on the downwardly sloped circumferential outer sidewall 1105 of the veterinarian e-bowl 1110.

FIG. 11-B is an illustration of a side view of a plurality of veterinarian e-bowls for a cat and small dog and shows the veterinarian e-bowls stacked and nested together. As shown in FIG. 11-B, a stacked or nesting configuration may comprise veterinarian e-bowls 1115, 1120, 1125, 1130, and 1135.

FIG. 11-C is an illustration of a cross section view of another embodiment of the veterinarian e-bowl for a cat and small dog and shows a pair of bumps or protrusions extending from the bottom of the receptacle portion to help facilitate removal when stacked or nested. As shown in FIG. 11-C, another embodiment of the veterinarian e-bowl 1110 may comprise protrusions 1140 and 1145, both of which may extend from the bottom exterior surface 1150 of the receptacle portion 1155 to facilitate removal of stacked or nested veterinarian e-bowls.

FIG. 11-D is an illustration of a bottom plan view of another embodiment of the veterinarian e-bowl for a cat and small dog and shows a plurality of ribs to help facilitate removal when stacked or nested. As shown in FIG. 11-D, another embodiment of the veterinarian e-bowl 1110 may comprise ribs 1160 and 1165 within sidewall 1170. The ribs 1160, 1165 may also help prevent jamming when multiple veterinarian e-bowls are nested. Jamming may occur when multiple veterinarian e-bowls are stuck due to nesting.

FIGS. 12-A through 12-B are illustrations of a plurality of embodiments of the veterinarian e-bowls for a cat or small dog and shows the veterinarian e-bowls stacked and nested. Specifically, FIG. 12-A is an illustration of a top perspective view of a plurality of another embodiment of the veterinarian e-bowls for a cat or small dog and shows the veterinarian e-bowls stacked and nested with the base portion of the veterinarian e-bowls facing downwards. As shown in FIG. 12-A, a stacked or nesting configuration may comprise veterinarian e-bowls 1200, 1205, 1210, 1215, 1220, 1230, 1235, 1240, 1245, 1250, 1255, 1260, 1265, and 1270.

FIG. 12-B is an illustration of a bottom perspective view of plurality of another embodiment of the veterinarian e-bowls for a cat or small dog and shows the veterinarian e-bowls stacked and nested with the rim portion of the veterinarian e-bowls facing downwards. As shown in FIG. 12-B, veterinarian e-bowl 1200 may be stacked into and within veterinarian e-bowl 1205. This process may be repeated to stack or nest as many veterinarian e-bowls as desired.

### Embodiments of Veterinarian E-Bowl for Medium to Large Dogs

FIGS. 13-A through 13-E are illustrations of another embodiment of a veterinarian e-bowl for a medium to large dog. Specifically, FIG. 13-A is an illustration of a cross-sectional view of one embodiment of a veterinarian e-bowl for a medium to large dog. As shown in FIG. 13-A, the veterinarian e-bowl 1300 may comprise a rim portion 1305, a downwardly sloped circumferential outer sidewall 1310, and a base portion 1315. FIG. 13-A also shows that the veterinarian e-bowl 1300 may comprise a flange 1320 with a non-skid material (as shown in FIG. 13-D) retained at least partially over the flange 1320. The outer sidewall 1310 may comprise at least one finger grip opening. The rim portion 1305 may be integrally formed with a receptacle portion 1325. The outer sidewall 1310 may form an interior chamber 1330 extending from the rim portion 1305 to a bottom opening 1335 surrounded by the base portion 1315. The receptacle portion 1325 may comprise a top opening 1340 surrounded by the rim portion 1305 and an inner sidewall 1345 terminating to a bottom 1350. The top opening 1340 may lead to a cavity 1355 surrounded by an interior surface 1360 of the inner sidewall 1345 and an interior surface 1365 of bottom 1350. A circumferential space 1370 may be disposed between the exterior surface 1375 of the inner sidewall 1345 and the interior surface 1380 of sloped outer sidewall 1310. The circumferential space 1370 may help nest multiple veterinarian e-bowls (as shown in FIG. 13-C) by having the rim portion 1305 of a first veterinarian e-bowl 1300 inserted through a bottom opening of a second veterinarian e-bowl.

The top opening 1340 may comprise a diameter less than the diameter of the base opening 1335. The rim portion 1305 may comprise a diameter greater than the diameter of the top opening 1340 and less than the diameter of the base opening 1335.

FIG. 13-B is an illustration of a side elevational view of another embodiment of a veterinarian e-bowl for a medium to large dog. The veterinarian e-bowl 1300 may have a preferred height of approximately 7 inches.

FIG. 13-C is an illustration of a side elevational view of a plurality of another embodiment of the veterinarian e-bowl for a medium to large dog and shows the veterinarian e-bowls stacked and nesting together. As shown in FIG. 13-C, a stacked or nesting configuration may include veterinarian e-bowls 1300, 1385, 1390, 1395 and 1396. In the stacked or nesting configuration, the rim portion of a first veterinarian e-bowl 1300 may be inserted through a bottom opening of a second veterinarian e-bowl 1385. Similarly, the rim portion of the second veterinarian e-bowl 1385 may be inserted through a bottom opening of a third veterinarian e-bowl 1390. This process may be repeated to stack or nest as many veterinarian e-bowls as desired.

FIG. 13-D is an illustration of a top perspective view of one embodiment of the veterinarian e-bowl for a medium to large dog wearing an e-collar. As shown in FIG. 13-D, the veterinarian e-bowl 1300 may comprise a rim portion 1305, a downwardly sloped circumferential outer sidewall 1310, and a base portion 1315. The rim portion 1305 may be integrally formed with a receptacle portion 1325. The outer sidewall 1310 may form an interior chamber extending from the rim portion 1305 to a bottom opening surrounded by the base portion 1315. The receptacle portion 1325 may have a top opening 1340 surrounded by the rim portion 1305 and may lead to a cavity surrounded by an inner sidewall 1345 and a bottom 1350. FIG. 9-D also shows that the veterinarian e-bowl 1300 may comprise a flange 1320 with a non-skid material retained at least partially over the flange 1320.

FIG. 13-E is an illustration of a top view of one embodiment of the veterinarian e-bowl for a medium to large dog wearing an e-collar. As shown in FIG. 13-E, the rim portion 1305 may be integrally formed with a receptacle portion 1325. The receptacle portion 1325 may be surrounded by the rim portion 1305 and an inner sidewall 1345 terminating to a bottom 1350. The outer sidewall 1310 may extend from the rim portion 1305 to a base portion 1315.

FIGS. 14-A through 14-C are illustrations of one embodiment of a non-skid material for veterinarian e-bowl for a medium to large dog. Specifically, FIG. 14-A is an illustration of a cross-sectional view of one embodiment of a non-skid material for veterinarian e-bowl for a medium to large dog. As shown in FIG. 14-A, a non-skid material 1400 may be disposed over and around the flange 1405 of the veterinarian e-bowl. The non-skid material 1400 may comprise an upper section 1410 having an interior surface 1415 and a lower section 1420 also having an interior surface 1425. The upper section 1410 and the lower section 1420 may be joined by integrally rounded by a sidewall 1430, which may have an interior surface 1435. A circumferential space 1440 may be formed and surrounded by the interior surfaces 1415, 1425, and 1435. The flange 1405 may be located within a circumferential space 1440.

FIG. 14-B is an illustration of an enlarged view of one embodiment of a non-skid material for veterinarian e-bowl for a medium to large dog. As shown in FIG. 14-B, one embodiment of an end portion of the non-skid material 1400 may comprise a rounded circumferential sidewall 1430, upper section 1410, and lower section 1420, wherein upper section 1410, and lower section 1420 are enlarged from the circle portion of the non-skid material 1400 illustrated in FIG. 14-A.

FIG. 14-C is an illustration of a top plan view of one embodiment of the non-skid material for veterinarian e-bowl for a medium to large dog. As shown in FIG. 14-C, the non-skid material 1400 may be disposed over and around the flange 1405 of the veterinarian e-bowl.

FIG. 15-A is an illustration of a top perspective view of another embodiment of the veterinarian e-bowl for a medium to large dog and shows the veterinarian e-bowl with at least one finger grip member. As show in FIG. 15-A, the finger grip member 1500 may be located on the downwardly sloped circumferential outer sidewall 1505 of the veterinarian e-bowl 1510.

FIG. 15-B is an illustration of a side view of a plurality of veterinarian e-bowls for a medium-large dog and shows the veterinarian e-bowls stacked and nested together. As shown in FIG. 11-B, a stacked or nesting configuration may comprise veterinarian e-bowls 1515, 1520, 1525, 1530, and 1535.

FIG. 15-C is an illustration of a cross section view of another embodiment of the veterinarian e-bowl for a medium to large dog and shows a pair of bumps or protrusions extending from the bottom of the receptacle portion to facilitate removal when stacked or nested. As shown in FIG. 15-C, another embodiment of the veterinarian e-bowl 1510 may comprise protrusions 1540 and 1545, both of which may extend from the bottom exterior surface 1550 of the receptacle portion 1555 to facilitate removal of stacked or nested veterinarian e-bowls.

FIG. 16-A through 16-B are illustrations of a plurality of embodiments of the veterinarian e-bowls for a medium to large dog and shows the veterinarian e-bowls stacked and nested. Specifically, FIG. 16-A is an illustration of a top perspective view of a plurality of another embodiment of the veterinarian e-bowls for a medium to large dog and shows the veterinarian e-bowls stacked and nested with the base portion of the veterinarian e-bowls facing downwards. As shown in FIG. 16-A, a stacked or nesting configuration may comprise veterinarian e-bowls 1600, 1605, 1610, 1615, 1620, 1630, 1635, 1640, 1645, 1650, 1655, 1660, 1665, and 1670.

FIG. 16-B is an illustration of a bottom perspective view of plurality of another embodiment of the veterinarian e-bowls for a medium to large dog and shows the veterinarian e-bowls stacked and nested with the rim portion of the veterinarian e-bowls facing downwards. As shown in FIG. 16-B, veterinarian e-bowl 1600 may be stacked into and within veterinarian e-bowl 1605. This process may be repeated to stack or nest as many veterinarian e-bowls as desired.

The foregoing description of the embodiments has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A veterinarian e-bowl compatible for an animal wearing an e-collar, comprising:
an outer sidewall, a rim portion, a base portion, and a receptacle portion;
wherein said outer sidewall extends outwardly and downwardly from said rim portion to said base portion, such that said outer sidewall is substantially frustum-shaped;
wherein said outer sidewall surrounds an interior space, such that said interior space substantially extends from said rim portion to said base portion;
wherein said receptacle portion comprises a top opening, an inner sidewall, and a bottom portion;
wherein said top opening of said receptacle portion is surrounded by said rim portion;
wherein said inner sidewall of said receptacle portion extends from said rim portion to said bottom portion of said receptacle portion; and
wherein said receptacle portion is elevated.

2. The veterinarian e-bowl according to claim 1, wherein said inner sidewall of said receptacle portion is inwardly sloped.

3. The veterinarian e-bowl according to claim 1, wherein said receptacle portion is configured to receive food and water.

4. The veterinarian e-bowl according to claim 1, wherein said base portion further comprises a flange.

5. The veterinarian e-bowl according to claim 4, wherein said flange of said base portion comprises a non-skid material; and
wherein said non-skid material is retained at least partially over said flange.

6. The veterinarian e-bowl according to claim 5, wherein said non-skid material is a gasket.

7. The veterinarian e-bowl according to claim 1, wherein said outer sidewall comprises at least one finger grip opening.

8. The veterinarian e-bowl according to claim 1, wherein a weight of said base portion is substantially heavier than a weight of said rim portion, such that said veterinarian e-bowl is substantially stable when resting on a surface.

9. The veterinarian e-bowl according to claim 1, wherein said veterinarian e-bowl weighs between approximately 0.5 to 2.5 pounds.

10. The veterinarian e-bowl according to claim 1, wherein said veterinarian e-bowl is approximately 4.25 inches in height.

11. The veterinarian e-bowl according to claim 1, wherein said veterinarian e-bowl is approximately 7 inches in height.

12. The veterinarian e-bowl according to claim 1, wherein said veterinarian e-bowl is configured to fit at least partially within an interior space of an e-collar worn by said animal, such that said animal is capable of consuming food and water located within said receptacle portion of said veterinarian e-bowl.

13. The veterinarian e-bowl of claim 1, wherein said receptacle portion is elevated at a height of at least approximately half of a height of said animal.

14. A veterinarian e-bowl compatible for an animal wearing an e-collar, comprising:
a first veterinarian e-bowl; and
a second veterinarian e-bowl;
wherein said first veterinarian e-bowl comprises:
an outer sidewall,
a rim portion,
a base portion, and
a receptacle portion;
wherein said outer sidewall extends outwardly and downwardly from said rim portion to said base portion, such that said outer sidewall is substantially frustum-shaped;
wherein said outer sidewall surrounds an interior space, such that said interior space substantially extends from said rim portion to said base portion;
wherein said interior space of said first veterinarian e-bowl is configured to accept and house said second veterinarian e-bowl, such that at least said first veterinarian e-bowl and second veterinarian e-bowl are nested;
wherein said receptacle portion comprises a top opening, an inner sidewall, and a bottom portion;
wherein said top opening of said receptacle portion is surrounded by said rim portion;
wherein said inner sidewall of said receptacle portion extends from said rim portion to said bottom portion of said receptacle portion; and
wherein said receptacle portion is elevated.

15. The veterinarian e-bowl according to claim 14, wherein said interior space of said first veterinarian e-bowl comprises at least one rib to prevent jamming during said nesting.

16. The veterinarian e-bowl according to claim 14, wherein said inner sidewall of said receptacle portion is inwardly sloped.

17. The veterinarian e-bowl according to claim 14, wherein said base portion further comprises a flange.

18. The veterinarian e-bowl according to claim 17, wherein said flange of said base portion comprises a non-skid material; and
wherein said non-skid material is retained at least partially over said flange.

19. The veterinarian e-bowl according to claim 14, wherein said outer sidewall comprises at least one finger grip opening.

20. A veterinarian e-bowl compatible for an animal wearing an e-collar, comprising:
an outer sidewall,
a rim portion,
a base portion, and
a receptacle portion;
wherein said outer sidewall extends outwardly and downwardly from said rim portion to said base portion, such that said outer sidewall is substantially frustum-shaped;
wherein said outer sidewall surrounds an interior space, such that said interior space substantially extends from said rim portion to said base portion;
wherein said outer sidewall comprises at least one finger grip opening;
wherein said base portion comprises a flange;
wherein said flange of said base portion comprises a non-skid material;
wherein said non-skid material is retained at least partially over said flange;
wherein said receptacle portion comprises a top opening, an inner sidewall, and a bottom portion;
wherein said top opening of said receptacle portion is surrounded by said rim portion;
wherein said inner sidewall of said receptacle portion extends from said rim portion to said bottom portion of said receptacle portion;
wherein said inner sidewall of said receptacle portion is inwardly sloped;
wherein said receptacle portion is elevated; and
wherein said receptacle portion is configured to receive food and water.
